(19) United States
(12) Patent Application Publication
(10) Pub. No.: US 2013/0241205 A1
(43) Pub. Date: Sep. 19, 2013

(54) Power Generating Apparatus

(71) Applicant: Adnan Mansoor, Glasglow (GB)

(72) Inventor: Adnan Mansoor, Glasglow (GB)

(21) Appl. No.: 13/877,999

(22) PCT Filed: Oct. 5, 2011
(86) PCT No.: PCT/GB2011/051902

§ 371 Date: Jun. 3, 2013

(30) Foreign Application Priority Data
Oct. 7, 2010 (GB) 1016872.2

(51) Int. Cl. F03B 13/20

(52) U.S. Cl. CPC F03B 13/20
USPC 290/53

(57) ABSTRACT

A power generating apparatus which is installable on a vessel, the apparatus comprising: a power generating device; a movable actuator coupled to the power generating device such that movement of the actuator causes the generating device to generate power;

and a mass which is movable in at least a first direction and a second opposite direction due to pitch or roll movement of the vessel, wherein the apparatus is adapted such that movement of the mass causes the mass to impact and move the actuator to generate power.

The present invention relates to apparatus provided on a vessel for generating power using wave motion. In particular, but not exclusively, the invention relates to generating power using a vessel subject to pitch and roll due to wave motion.

Various wave power devices exist. Often, the apparatus use the vertical rise and fall of a device such as a buoy to generate power. The entire apparatus has to be manufactured and subsequently has no other purpose than to generate power, and the cost of the apparatus can be substantial.

A vessel such as a ship or boat is subject to pitch (longitudinal rotation) and roll (lateral rotation) when at sea. Even in calm weather, a ship typically experiences around 10° of roll. The vessel may have ballast tanks and/or stabiliser fins to control stability. The pivot point about which the vessel rolls is termed the metacentre, m. This is different from, and generally higher up than, the centre of gravity, g. The vertical position of g depends on the weight of the vessel and, if lower decks are flooded using the ballast tanks, the mass of the vessel will be greater at the bottom and so g will move downwards. However, the position of the metacentre will not change.

Conventionally, diesel engines are used to power a ship. A typical cost of the heavy fuel oil used for the engines is around $30,000 per day. The ship typically travels in shipping lanes and one reason these lanes are chosen is that they are generally calm waters. However, they are often not the most direct route between destinations.

According to a first aspect of the present invention, there is provided a power generating apparatus which is installable on a vessel, the apparatus comprising:
a power generating device;
a movable actuator coupled to the power generating device such that movement of the actuator causes the generating device to generate power; and
a mass which is movable in at least a first direction and a second opposite direction due to pitch or roll movement of the vessel,
wherein the apparatus is adapted such that movement of the mass causes the mass to impact and move the actuator to generate power.

The movable actuator may comprise a piston which is retractable to compress or move a fluid. The power generating device may comprise a turbine which is moved by the fluid to generate power.

The mass may comprise a rolling member, such as a ball or cylinder. Alternatively, the mass may comprise a sliding member.

The apparatus may include a guide member for the mass. The guide member may be adapted to limit movement of the mass to the first and second directions. The guide member may comprise one or more rails, troughs, conduits or the like for the mass. The mass may be rollably or slidably connected to the guide member.

The mass may be linearly movable in the first and second directions. Alternatively, the mass may be rotationally movable in the first and second directions.

In an alternative embodiment, the mass may comprise a hammer member. The hammer member may be pivotably fixed at a surface of the vessel and rotatable about the pivot fixing to impact and move the actuator.

A set of two actuators may be provided. The mass may be provided between the two actuators. The guide member may extend between the two actuators. Each actuator may be provided at opposite ends of the vessel in a lateral or longitudinal axis of the vessel.

Alternatively, the mass may comprise a component of the vessel, such as cargo or a portion of the infrastructure of the vessel. The apparatus may include a support member for the component which provides controlled movement to impact and move the actuator. Alternatively, the mass may comprise a fluid contained within the vessel which is movable due to pitch or roll to apply pressure to the actuator to move the actuator to generate power.

The effective distance between the two actuators of the set may be variable. The apparatus may include sensing means for measuring the frequency of the pitch or roll of the vessel. The apparatus may include control means for varying the distance between the two actuators based upon the measured frequency.

The apparatus may include a pitching or rolling sensor to measure the magnitude of movement of the vessel. The apparatus may include means for preventing or limiting movement of the mass when the magnitude of vessel movement exceeds a predetermined value. The means may be adapted to cease movement of the mass, or to limit the movement to within a set of stops, or to slow movement of the mass. The means may comprise a cage member, an anchor device, a set of stops, a brake member or the like.

The apparatus may include means for controlling the amount of pitch or roll of the vessel. The controlling means may comprise means for varying the distance between the metacentre and the centre of gravity. The varying means may be provided by ballast tanks of the vessel. Alternatively or in addition, the controlling means may comprise one or more stabiliser fins which are deployable to reduce pitch or roll or retractable.

A plurality of sets of actuators may be provided at the vessel, the sets being serially arranged in a horizontal direction. The horizontal direction may be one or both of lateral and longitudinal. Alternatively or in addition, a plurality of sets may be serially arranged in a vertical direction. The mass of the mass and/or the number of sets provided at a particular vertical level may vary depending on the vertical distance from the metacentre.

The vessel may comprise a ship or boat. The vessel may be anchorable at a first point of the vessel. The first point of the vessel may be provided at one end of the vessel and the vessel may be anchorable at a second point at a second opposite end of the vessel.

The first and second anchoring points of the vessel may vertically correspond to the metacentre of the vessel. The first and second anchoring points of the vessel may be provided at each longitudinal end of the vessel. This restrains the vessel from movement in all directions except for rolling rotation about the metacentre. Alternatively, the first and second anchoring points of the vessel may be provided at each lateral end of the vessel. This restrains the vessel from movement in all directions except for pitching rotation about the metacentre.

An arm assembly may be provided at the metacentre for extending the anchoring point outwards towards or beyond the boundary of the vessel. This avoids interference between the anchor line and a portion of the vessel such as the hull.

The apparatus may include an electrical conduit which is connectable between the power generating device and an onshore connector.

Alternatively or in addition, the generated power may be stored in storage devices on the vessel such as batteries. The generated power may be used to power the vessel. The vessel may be adapted to carry cargo and/or passengers.

According to a second aspect of the present invention there is provided a vessel including a power generating apparatus in accordance with the first aspect of the invention.

According to a third aspect of the present invention there is provided a method of generating power comprising the steps of:
installing on a vessel a power generating apparatus comprising a power generating device and a movable actuator coupled to the power generating device such that movement of the actuator causes the generating device to generate power;
providing a mass on the vessel, the mass being movable in at least a first direction and a second opposite direction due to pitch or roll movement of the vessel such that movement of the mass causes the mass to impact and move the actuator to generate power.

The method may include guiding the mass to limit movement of the mass to the first and second directions. The method may include providing the mass between a set of two actuators.

The method may include using a component of the vessel, such as cargo or a portion of the infrastructure of the vessel, as the mass. Alternatively, The method may include using a fluid contained within the vessel as the mass.

The method may include varying the effective distance between the two actuators of the set. The method may include measuring the frequency of the pitch or roll of the vessel. The method may include varying the distance between the two actuators based upon the measured frequency.

The method may include measuring the magnitude of movement of the vessel. The method may include preventing or limiting movement of the mass when the magnitude of vessel movement exceeds a predetermined value.

The method may include controlling the amount of pitch or roll of the vessel. The step of controlling the amount of pitch or roll of the vessel may comprise varying the distance between the metacentre and the centre of gravity.

The method may include providing a plurality of sets of actuators at the vessel.

The method may include anchoring the vessel at a first and second point of the vessel, the points provided at opposite ends of the vessel. The method may include vertically locating the first and second anchoring points at the metacentre of the vessel such that the vessel is restrained from movement in all directions except for rotation about the metacentre. The method may include providing an arm assembly at the metacentre to extend the anchoring point outwards towards or beyond the boundary of the vessel.

The method may include connecting an electrical conduit between the power generating device and an onshore connector.

Alternatively, the method may include storing the generated power in storage devices on the vessel. Alternatively or in addition, the method may include using the generated power to power the vessel.

The method may include sailing the vessel within one or more geographic regions that are known to produce substantial pitch or roll. The or each geographic region may be distinct from known shipping lanes.

According to a fourth aspect of the present invention there is provided a method of anchoring a vessel comprising the steps of:
connecting an anchor line of a first anchor at a first point located at a first end of the vessel;
connecting an anchor line of a second anchor at a second point located at a second opposite end of the vessel; and
deploying each anchor,
wherein each of the first and second points correspond to the metacentre of the vessel such that rotational movements of the vessel are unconstrained while movement in all other degrees of freedom is constrained.

The first and second anchoring points of the vessel may be provided at each longitudinal end of the vessel. Alternatively, the first and second anchoring points of the vessel may be provided at each lateral end of the vessel.

The method may include providing an extending member at one or both of the first and second points and connecting the anchor line to the free end of the extending member.

Embodiments of the present invention will now be described, by way of example only, with reference to the accompanying drawings in which:

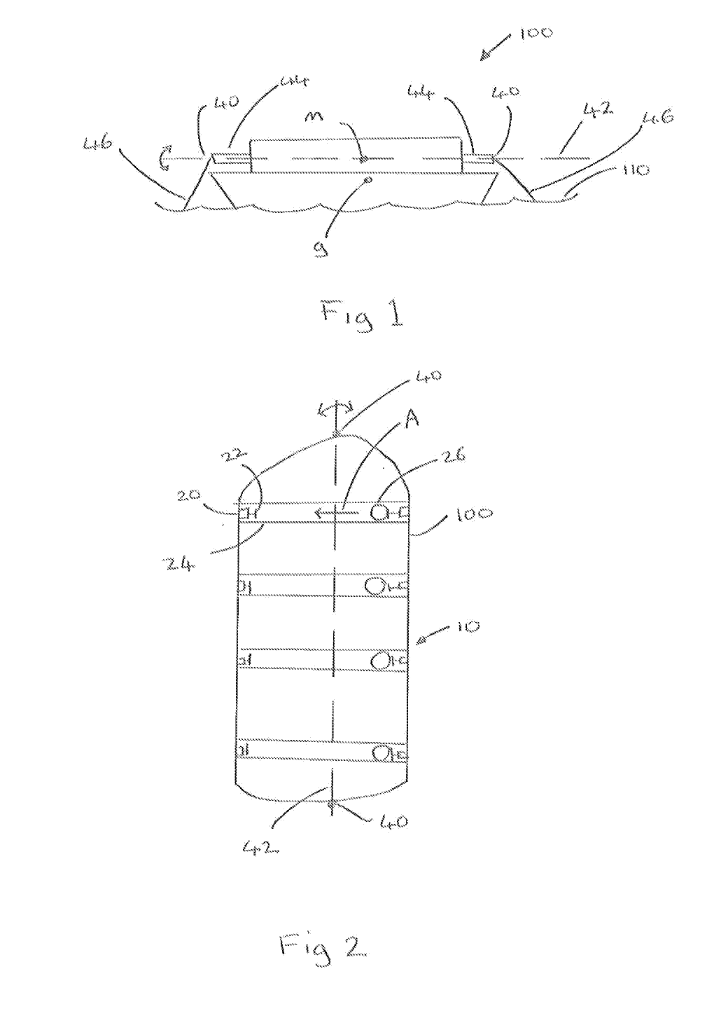

FIG. 1 shows a side view of a vessel including a first embodiment of a power generating apparatus;

FIG. 2 shows a plan view of the vessel of FIG. 1;

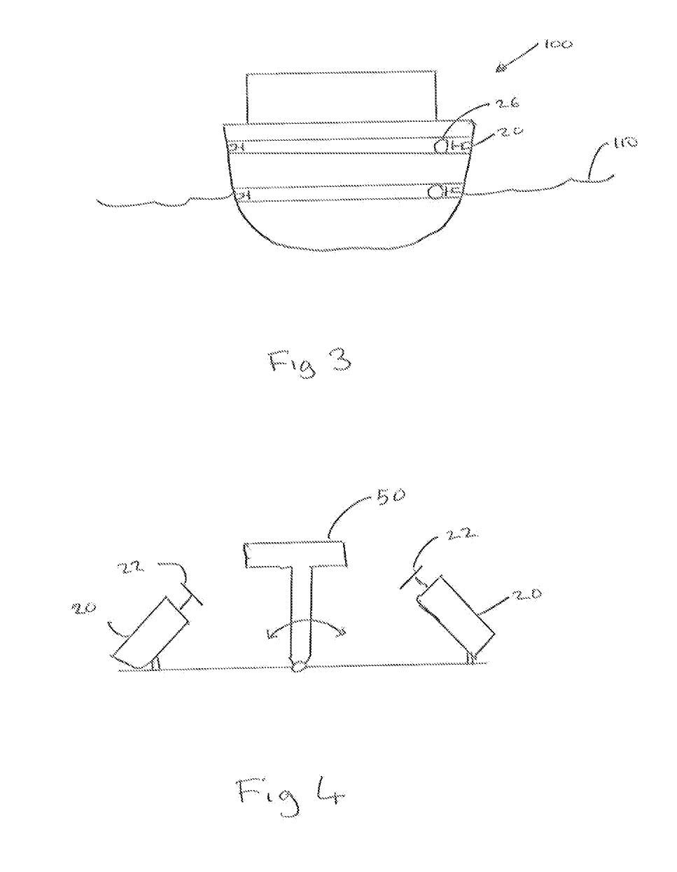

FIG. 3 shows an end view of the vessel of FIG. 1; and

FIG. 4 shows a second embodiment of a power generating apparatus;

FIG. 1 shows a vessel in the form of a ship 100 in a body of water 110 which includes a power generating apparatus 10 as shown in FIGS. 2 to 4. The apparatus 10 comprises a power generating device in the form of a turbine device (not shown) which converts rotation of a set of turbine blades into electricity.

The turbine blades are rotated when a movable actuator in the form of the head 22 of a piston 20 is retracted to pressurise a hydraulic fluid. The piston 20 includes a spring (not shown) for returning the piston head 22 to the extended position.

As shown in FIGS. 2 and 3, a piston 20 is provided at each lateral end of the ship 100, the two pistons forming a cooperating set, and a guide channel 24 extends between the two pistons 20. A mass in the form of a heavy ball 26 is located within the channel 24. The ship 100 includes a number of these piston/channel/ball systems arranged in series and running laterally across the ship 100.

The ball 26 is free to roll within the channel 24 from one end to the other and back in response to rolling of the ship 100. As the ship 100 rolls, each channel 24 will change in orientation to have a particular gradient, the value of the gradient dependent on the degree of rolling. The ball 26 at the summit of the gradient will roll along the channel 24 in direction A, picking up momentum and accelerating as it rolls. When the ball 26 reaches the end of the channel 24, it will strike the piston head 22 located there with an impact force equal to the product of its mass and deceleration as it slows to a stop at the end of the channel 24. This impact force is predetermined to be sufficient to fully retract the piston head 22. Each piston/channel/ball system will therefore contribute to generating power. The balls 26 will all tend to move simultaneously in the same manner as they are all subject to the same rolling action of the ship 100.

It is desirable that the balls' striking of the piston heads 22 is coordinated with the peaks of rolling of the ship 100 to fully utilise the available energy of the rolling balls 26. Therefore, it is desirable to ensure that the rolling distance of the balls 26 (determined by the length of the channels 24) corresponds with the frequency of rolling of the ship 100. To achieve this, the effective distance between the set of two piston heads 22 can be adapted to be variable. For instance, one or both pistons 20 can be attached to a mount (not shown) which is laterally movable inwards towards the centre of the ship 100. One or more sensors (not shown) can be used to measure the frequency of the roll of the ship 100. A controller (not shown) can be adapted to vary the distance between the two piston heads 22 by moving one or both of the associated mounts by a distance based upon the measured frequency.

One or more sensors (not shown) can also be provided to measure the magnitude of rolling movement of the ship 100. When the rolling of the ship 100 as measured by the sensors exceeds a safe value, movement of the balls 26 can be prevented or limited. For instance, a brake in the form of rubber pads (not shown) provided in the channels 24 can be deployed to slow the balls 26 or, if further deployed, bring the balls 26 to a stop. The degree of deployment of the brake can be adapted to be dependent on the measured magnitude of rolling. Slowing, rather than stopping, the balls 26 has the advantage that the apparatus continues to operate (and produce power) even in harsh conditions.

It is also possible, either instead of or in addition to directly controlling ball movement, to control the amount of roll of the ship 100. This can comprise varying the distance between the metacentre and the centre of gravity. Two means of doing this are using the ballast tanks of the ship 100 and the stabiliser fins of the ship 100.

Also, the steering of the ship 100 can be controlled, in response to the measured magnitude of rolling movement of the ship 100, so that the ship 100 is at the optimum orientation for experiencing rolling within the desired range.

As shown in FIG. 3, the piston/channel/ball systems can also be serially arranged in a vertical direction. The mass of the balls 26 can be adapted to vary depending on the vertical distance from the metacentre m.

As shown in FIGS. 1 and 2, the ship 100 can be anchored at two points 40, the points 40 provided at opposite longitudinal ends of the ship 100. The anchoring points 40 are configured to vertically correspond to the metacentre of the ship 100. This restrains the vessel from movement in all directions except for rolling rotation about a longitudinal axis 42 passing through the metacentre m, whereas the rolling rotation is substantially unrestrained. An arm assembly 44 coincident with the metacentric axis 42 extends the anchoring points 40 outwards to avoid interference between the anchor line 46 and the hull of the ship 100.

With this configuration, the ship 100 is permanently anchored for as long as power generation is desired. The ship 100 can be anchored close to shore and an electrical conduit (not shown) can be connected between the power generating device and an onshore connector connected to the main grid.

However, the ship 100 can alternatively be used as a working vessel, such as to carry cargo and/or passengers. The generated power can be stored in batteries and can be used to power the vessel which would provide a substantial reduction in fuel costs.

FIG. 4 shows an alternative embodiment of the apparatus 10. Rather than using a ball which rolls within a channel, the mass comprises a hammer 50 which is again provided between two piston heads 22. The hammer 50 is pivotably fixed at a surface of the ship 100. Rolling of the ship 100 causes the hammer 50 to rotate relative to the ship 100 about the pivot fixing 52 to sequentially impact and move each piston head 22.

Various modifications can be made without departing from the scope of the present invention.

1. A power generating apparatus which is installable on a vessel, the apparatus comprising:
a power generating device;
a movable actuator coupled to the power generating device such that movement of the actuator causes the generating device to generate power; and
a mass which is movable in at least a first direction and a second opposite direction due to pitch or roll movement of the vessel,
wherein the apparatus is adapted such that movement of the mass causes the mass to impact and move the actuator to generate power.

2. An apparatus as claimed in claim 1, wherein the movable actuator comprises a piston which is retractable to compress a fluid.

3. An apparatus as claimed in claim 2, wherein the power generating device comprises a turbine which is moved by the fluid to generate power.

4. An apparatus as claimed in claim 3, wherein the mass comprises a rolling member.

5. An apparatus as claimed in claim 4, including a guide member for the mass, the guide member adapted to limit movement of the mass to the first and second directions.

6. An apparatus as claimed in claim 1, wherein the mass is linearly movable in the first and second directions.

7. An apparatus as claimed in claim 1, wherein the mass is rotationally movable in the first and second directions, and wherein the mass comprises a hammer member which is pivotably fixed at a surface of the vessel and rotatable about the pivot fixing to impact and move the actuator.

8. An apparatus as claimed in claim 1, wherein a set of two actuators are provided, the mass being provided between the two actuators.

9. An apparatus as claimed in claim 8, wherein the guide member extends between the two actuators, and wherein each actuator is provided at opposite ends of the vessel in a lateral or longitudinal axis of the vessel.

10. An apparatus as claimed in claim 1, wherein the mass comprises a component of the vessel.

11. An apparatus as claimed in claim 8, wherein the effective distance between the two actuators of the set is variable.

12. An apparatus as claimed in claim 11, wherein the apparatus includes sensing means for measuring the frequency of the pitch or roll of the vessel and the apparatus includes control means for varying the distance between the two actuators based upon the measured frequency.

13. An apparatus as claimed in claim 1, wherein the apparatus includes a pitching or rolling sensor to measure the magnitude of movement of the vessel and the apparatus includes a means for limiting movement of the mass when the magnitude of vessel movement exceeds a predetermined value.

14. An apparatus as claimed in claim 1, including means for controlling the amount of pitch or roll of the vessel.

15. An apparatus as claimed in claim 14, wherein the controlling means comprises means for varying the distance between the metacentre and the centre of gravity.

16. An apparatus as claimed in claim 1, including a plurality of sets of actuators provided at the vessel, the sets being serially arranged in a horizontal direction.

17. An apparatus as claimed in claim 1, including a plurality of sets of actuators provided at the vessel, the sets being serially arranged in a vertical direction.

18. An apparatus as claimed in claim 1, wherein the vessel is anchorable at a first point of the vessel, the first point provided at one end of the vessel, and the vessel is anchorable at a second point provided at a second opposite end of the vessel.

19. An apparatus as claimed in claim 18, wherein the first and second anchoring points of the vessel vertically correspond to the metacentre of the vessel.

20. An apparatus as claimed in claim 19, wherein an arm assembly is provided at the metacentre for extending the anchoring point outwards towards or beyond the boundary of the vessel.

21. An apparatus as claimed in claim 1, including an electrical conduit which is connectable between the power generating device and an onshore connector.

22. An apparatus as claimed in claim 1, wherein at least a portion of the generated power is stored in storage devices on the vessel.

23. An apparatus as claimed in claim 22, wherein at least a portion of the generated power is used to power the vessel.

24. A vessel including a power generating apparatus as claimed in claim 23.

25. A method of generating power comprising the steps of:
installing on a vessel a power generating apparatus comprising a power generating device and a movable actuator coupled to the power generating device such that movement of the actuator causes the generating device to generate power;
providing a mass on the vessel, the mass being movable in at least a first direction and a second opposite direction due to pitch or roll movement of the vessel such that movement of the mass causes the mass to impact and move the actuator to generate power.

26. A method as claimed in claim 25, including guiding the mass to limit movement of the mass to the first and second directions.

27. A method as claimed in claim 25, including providing the mass between a set of two actuators.

28. A method as claimed in claim 25, including varying the effective distance between the two actuators of the set.

29. A method as claimed in claim 25, including controlling the amount of pitch or roll of the vessel by varying the distance between the metacentre and the centre of gravity.

30. A method as claimed in claim 25, including anchoring the vessel at a first and second point of the vessel, the points provided at opposite ends of the vessel.

31. A method as claimed in claim 30, including vertically locating the first and second anchoring points at the metacentre of the vessel such that the vessel is restrained from movement in all directions except for rotation about the metacentre.

32. A method as claimed in claim 31, including providing an arm assembly at the metacentre to extend the anchoring point outwards beyond the boundary of the vessel.

33. A method as claimed in claim 25, including connecting an electrical conduit between the power generating device and an onshore connector.

34. A method as claimed in claim 25, including sailing the vessel within one or more geographic regions that are known to produce substantial pitch or roll.

35. A method of anchoring a vessel comprising the steps of:
connecting an anchor line of a first anchor at a first point located at a first end of the vessel;
connecting an anchor line of a second anchor at a second point located at a second opposite end of the vessel; and
deploying each anchor,
wherein each of the first and second points correspond to the metacentre of the vessel such that rotational movements of the vessel are unconstrained while movement in all other degrees of freedom is constrained.

36. A method as claimed in claim 35, wherein the first and second anchoring points of the vessel are provided at each longitudinal end of the vessel.

37. A method as claimed in claim 35, wherein the first and second anchoring points of the vessel are provided at each lateral end of the vessel.

38. A method as claimed in claim 35, including providing an extending member at one or both of the first and second points and connecting the anchor line to the free end of the extending member.
